(19) United States
(12) Patent Application Publication
(10) Pub. No.: US 2004/0179219 A1
(43) Pub. Date: Sep. 16, 2004

(54) Print job configuration

(76) Inventors: Howard G. Wong, Portland, OR (US); John C. Goetz, Brush Prairie, WA (US); Elizabeth J. Atwater, Vancouver, WA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/386,003

(22) Filed: Mar. 10, 2003

(51) Int. Cl. G06F 15/00

(52) U.S. Cl. 358/1.13; 358/1.6

(57) ABSTRACT

Systems, methods, and devices for print job configuration are provided. A method includes receiving print media data indicating a print media type available to a printing device and configuring a print mode displayable by an indicator located on the printing device to accord with the received print media data.

Printing devices, such as ink and laser printing devices, among others, operate according to control signals, commands, and/or computer readable instruction sets to effectuate print jobs that transfer ink and toner, among others onto print media to form an image thereon. Images printed on print media can include, for example, text or one or more photographs or drawings, or a combination of text, photographs, and/or drawings.

Print jobs can be used to create many different types of printed items. For example, printing devices can be utilized to print photo lab quality photographs, brochures, draft documents, letterhead documents, envelopes, and business cards, among others. In the creation of these different types of printed items, the type of print media utilized and the resolution of the ink on the media, for example, can be adjusted to change the quality of a printed image.

Operation of a printing device is administered by one or more controllers such as, for example, a microprocessor controlled printed circuit board and one or more application specific integrated circuits (ASIC's or chipsets) connected by appropriate interfaces, e.g. cabling. Among their many functions, the controllers can adjust the delivery of the ink as it is applied to the print media based upon the printed item to be created.

Additionally, the type of print media can be selected from many different types depending upon the specific printed item that is to be created. For example, print media types include draft paper, photo paper, cardstock, letterhead, envelopes, business cards, and transparencies, among others. Some types of print media have special coatings or are specially constructed to provide a better image quality when an image is printed thereon. These types of media are often capable of utilizing more ink to thereby allow greater resolution of the images created. These special types of media are also generally more expensive than ordinary media such as draft paper and, accordingly, more care needs to be taken to minimize the waste of these types of media.

In some instances, a print mode and the print media available on a printing device are not optimized for the printing properties of a print job. That is, one type of print job can include a print job for printing a text document requiring a resolution of, for example, 300 Dots Per Inch (DPI) or less. In this example, a user would want draft paper or letterhead available to the printing device. Another type of print job can include a print job for a photograph requiring a resolution of, for example, 1200, 2400, or more DPI and/or the use of image scaling, dithering, and other functions. In this example, a user would want high quality photo paper available to the printing device.

When a less than optimal type of print media is accessible to the printing device, a user typically has to cancel a print job already printing on the incorrect media and manually either change the type of media available or adjust the print mode settings via a host device to avoid the continued undesired use of consumables which do not match the needs of a print job. For example, if only draft paper is available, it can be wasteful to execute a print job with an unnecessarily high resolution. Similarly, it can be wasteful to execute a print job with an unsatisfactorily low resolution on high quality photo paper. Additionally, many currently available devices and systems do not prominently identify that there are different print modes that can exist in printing devices.

### BRIEF DESCRIPTION OF THE DRAWINGS

FIG. 1 illustrates a system environment according to various embodiments of the present invention.

FIGS. 2A and 2B illustrate embodiments of devices which are operable to implement or which can include embodiments of the present invention.

FIG. 2C illustrates a block diagram embodiment of one or more components includable in a device, such as the devices shown in FIGS. 2A and 2B.

FIG. 3 illustrates a method embodiment.

FIG. 4 illustrates another method embodiment.

FIG. 5 illustrates another method embodiment.

FIG. 6 illustrates another method embodiment.

### DETAILED DESCRIPTION

The present invention provides improved techniques for print job configuration and includes systems and devices for performing the same. Various embodiments of the present invention provide enhanced print mode functionality at the printing device, by displaying the print mode thereon. Various embodiments of the present invention also allow the print mode to be reviewed, accepted, and/or changed at the print device.

Embodiments of the present invention enable print mode selection without having to change settings in a printer driver. For example, in various embodiments, a printing device coordinates with a print media sensing device to automatically change a print mode based upon the media sensed by the sensing device, if the media is different from that originally selected. This bypasses the need to change driver settings manually.

Various embodiments of the present invention include a print mode indicator. The print mode indicator can be operable to indicate what print mode is currently being utilized, to indicate what print mode is to be utilized on a print job ready to be printed, or to indicate that there is a mismatch between the print mode and the type of media to be utilized. The print mode indicator can be one or more illuminating indicators or one or more audible alarms. However, the invention is not so limited.

In various embodiments, the print mode indicator is integrated into the outer panel of a print device. In various embodiments, the print indicators can also be coupled with one or more print mode selectors. The one or more selectors can be buttons or other actuators that enable a print mode to be selected.

For example, in various embodiments several illuminating indicators can be present on the outer panel of a print device, however, the invention is not so limited. In this embodiment, when a print mode is selected, an indicator corresponding to that print mode is illuminated. In various embodiments, each indicator also has a corresponding print mode selector in the form of a button provided on the outer panel of the device, however, the invention is not so limited. A user can then confirm or change the print mode, by actuating the button corresponding to the print mode desired. Those skilled in the art will appreciate that the selection of a print mode can be achieved by one or more buttons.

In function, the device can be passive and/or active. That is, for example, the device can be passive, i.e. provide passive print mode adjustment, in that it will wait for a user to confirm that the correct print mode is selected, or toggle between print modes to select a new mode. This can be accomplished by the physical actuation of a button on the control panel of the printing device. However, the invention is not so limited. The device can be active, i.e. provide active print mode adjustment, in that it will automatically change print modes based upon the media that is detected by a print media sensing device. This can be accomplished through use of software or firmware, among others. The invention is not so limited.

As one of ordinary skill in the art will appreciate upon reading this disclosure, various embodiments of the invention can be performed in one or more devices, device types, and system environments including networked environments. The discussion which follows illustrates, by way of example and not by way of limitation, various system environments and devices that implement or include embodiments of the present invention.

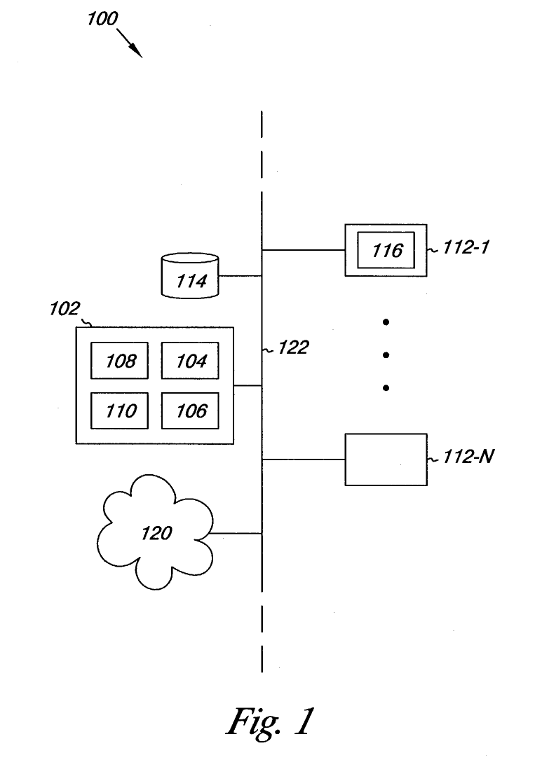

FIG. 1 illustrates a system environment 100 according to various embodiments of the present invention. As shown in FIG. 1, the system 100 includes a printing device 102. In various embodiments, including the embodiment shown in FIG. 1, the printing device 102 can include one or more processors and/or application modules 104, one or more memory devices 106, and a print engine 110. The one or more processors and/or application modules 104 are operable on computer readable instructions for processing information and data as the same will be known and understood by one of ordinary skill in the art. In various embodiments of the invention, the one or more processors and/or application modules 104 are operable on computer readable instructions for interpreting received image data.

In the various embodiments, the one or more memory devices 106 include memory devices 106 on which computer readable instructions, data, and other information can be stored, temporarily or otherwise. In various embodiments, the one or more memory devices 106 can include fixed memory, such as a hard drive, a memory chip on a printed circuit board, and the like. The one or more memory devices 106 can include memory devices 106 such as Non-Volatile (NV) memory (e.g. Flash memory), RAM, ROM, DDRAM, magnetic media, optically read media, and the like. The invention is not so limited.

As shown in the embodiment of FIG. 1, the printing device 102 can include a printing device driver 108 and a print engine 110. In various embodiments of FIG. 1, additional printing device drivers 116 can be located off the printing device 102 such as for example on a remote device, e.g. remote device 112-1 in FIG. 1. Such additional printing device drivers can be an alternative to the printing device driver 108 located on the printing device 102 or provided in addition to the printing device driver 108. As one of ordinary skill in the art will understand, a printing device driver 108 is operable to create a computer readable instruction set for a print job utilized for rendering images by the print engine 110. Printing device driver 108 includes any printing device driver suitable for carrying out various aspects of the present invention. That is, the printing device driver can take data from one or more software applications and transform the data into a print job.

When a printing device is utilized to print an image on a piece of print media, a print job is created that provides instructions on how to print the image. These instructions are communicated in a Page Description Language (PDL) to initiate a print job. PDL's are device independent, high level languages for instructing the printing engine of the printing device to print text and graphics on a page. Two major languages currently in use are Adobe's Postscript and Hewlett-Packard's PCL (print control language). The PDL can include a list of printing properties for the print job. Printing properties include, by way of example and not by way of limitation, the size of the image to be printed, its positioning on the print media, resolution of a print image (e.g. Dots Per Square Inch (DPI)), a printing device speed (e.g. Pages Per Minute (PPM)), color settings, simplex or duplex setting, indications to process image enhancing algorithms (e.g. halftoning), and the like.

A print job involves utilizing a printer driver to create an instruction set which is sent to a printing engine for rendering an image. A Page Description Language (PDL) is one form of an instruction set associated with a print job. In some devices and systems, a printer driver can be located remotely in a desktop computer, laptop computer, workstation, or other host computer which is interfaced to a printing device containing a printing engine.

Based on the content of the image, and the desired printed item to be created, a printer can be optimized to print the image on a piece of print media by changing the instructions and properties of the printing process. For example, printing devices typically have several different print modes and each mode is suited for different sets of printing properties. Examples of print modes include, by way of example and not by way of limitation, print quality settings such as fast draft, draft, fast normal, normal, photograph, best, and maximum DPI. Furthermore, each print mode can produce a different quality of output depending on the kind of media being printed upon, whether the media is manually selected or determined automatically by a print media sensor.

For instance, printing devices typically have a print media input mechanism that can accept many different types of print media. The print media can be accessed by the print media input mechanism at one or more locations. For example, the print media can reside in one or more bins or trays, and software can be utilized to identify to the print device what type of print media is resident in a particular location. The identification of the print media type can occur prior to or after a print job is initiated.

As one of ordinary skill in the art will appreciate upon reading this disclosure, the printing device 102 includes a printing device operable to print images. In the various embodiments, the printing device 102 can include a single-function printing device, such as the line of DeskJet printing devices, or photo printing device, such as the line of Photosmart printing devices sold by the Hewlett-Packard Company. In the various embodiments, the printing device 102 can include multiple functions. For example, Hewlett Packard produces several devices that provide printing, copying, and scanning. Additionally, some of these multi-function devices also include faxing capabilities. These types of devices are generally referred to as PCS (Printing/Copying/Scanning) devices or as All-in-One (AiO) devices.

As shown in the embodiment of FIG. 1, printing device 102 can be networked to one or more remote devices 112-1, . . . , 112-N over a number of data links, shown as 122. As one of ordinary skill in the art will appreciate upon reading this disclosure, the number of data links 122 can include one or more physical connections, one or more wireless connections, and any combination thereof, as part of a network. That is, the printing device 102 and the one or more remote devices 112-1, . . . , 112-N can be directly connected and/or can be connected as part of a wider network having a plurality of data links 122.

It is noted that any number of remote devices and remote device types 112-1, . . . , 112-N can be networked to the printing device 102. The invention is not so limited. That is, in various embodiments, the one or more remote devices 112-1, . . . , 112-N can include a remote device such as a wireless phone, a personal digital assistant (PDA), or other handheld device.

In various embodiments, the one or more remote devices 112-1, . . . , 112-N can include remote devices such as one or more desktop computers, laptop computers, or workstations, among other device types. In some instances, one or more remote devices 112-1, . . . , 112-N can include one or more peripheral devices distributed within the network. Examples of peripheral devices include, but are not limited to, scanning devices, fax capable devices, copying devices, and the like. As noted above, in various embodiments, a printing device 102 can include a multi-function device having several functionalities such as printing, copying, and scanning included. As will be known and understood by one of ordinary skill in the art, such remote devices 112-1, . . . , 112-N can also include one or more processors and/or application modules suitable for running software and can include one or more memory devices thereon.

As shown in the embodiment of FIG. 1, a system 100 can include one or more networked storage devices 114, e.g. remote storage database and the like. Likewise, the system 100 can include one or more Internet connections 120.

As one of ordinary skill in the art will appreciate upon reading this disclosure, the network described herein can include any number of network types including, but not limited to, a Local Area Network (LAN), a Wide Area Network (WAN), a Personal Area Network (PAN), and the like. And, as stated above, data links 122 within such networks can include any combination of direct or indirect wired and/or wireless connections, including but not limited to electrical, optical, and RF connections.

As one of ordinary skill in the art will appreciate upon reading this disclosure, memory, such as memory 106 and memory 114, can be distributed anywhere throughout a networked system. Memory, as the same is used herein, can include any suitable memory for implementing the various embodiments of the invention. Thus, memory and memory devices include fixed memory and portable memory. Examples of portable memory include memory cards, memory sticks, flash cards, and the like. Other memory mediums include CDs, DVDs, and floppy disks. The invention, however, is not limited to any particular type of memory medium and is not limited to where within a device or networked system a set of computer instructions reside for use in implementing the various embodiments of invention. One of ordinary skill in the art will appreciate the manner in which software, e.g. computer readable instructions, can be stored on a memory medium.

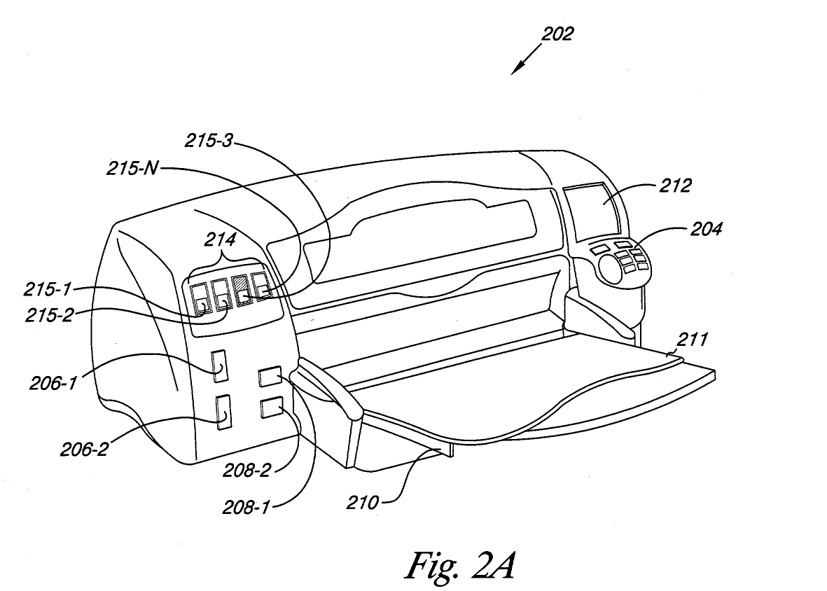

FIGS. 2A and 2B illustrate embodiments of devices that are operable to implement or include embodiments of the present invention. As one of ordinary skill in the art will appreciate upon reading this disclosure, embodiments of the invention are not limited to inclusion with or implementation on those devices illustrated in FIGS. 2A and 2B.

FIG. 2A illustrates an embodiment of a printing device 202. One of ordinary skill in the art will be familiar with the purpose and functionality of a printing device. And, as one of ordinary skill in the art will appreciate upon reading this disclosure, the printing device 202 illustrated in the embodiment of FIG. 2A can operate as a stand alone device and/or can be used as a printing device in a system, such as the printing device 102 shown in the system 100 of FIG. 1.

Printing devices, such as printing device 202, are operable to receive image data from one or more sources and can operate on such image data to transfer the data to print media. As shown in the embodiment of FIG. 2A, the printing device 202 can include one or more data input mechanisms. As shown in the embodiment of FIG. 2A, the one or more data input mechanisms include one or more input keys 204, such as on a control panel, one or more media slots 206-1 and 206-2 operable to receive one or removable memory, such as a flash memory card, and one or more data ports 208-1 and 208-2 operable to receive additional data input. By way of example, and not by way of limitation, many printing devices allow users to conveniently input a memory card from a digital camera.

As one of ordinary skill in the art will appreciate upon reading this disclosure, the one or more data ports 208-1 and 208-2 can include a data port operable to receive parallel or serial data connection. For example, the one or more data ports 208-1 and 208-2 can include a data port configured to receive a high speed serial cable connection, such as a USB cable. The invention, however, is not so limited. The one or more data ports 210-1 and 210-2 can further include a data port configured to receive data in a wireless fashion, such as by using an IR or Bluetooth wireless mechanism.

As one of ordinary skill in the art will appreciate, the printing device 202 embodiment of FIG. 2A is thus operable to obtain data, of any type, from any number of sources. As one of ordinary skill in the art will appreciate upon reading this disclosure, data in the various embodiments includes information such as user commands, image data, and computer readable instructions or instruction sets, among others.

As shown in the embodiment of FIG. 2A, some printing devices can include a display screen 212, such as an LCD, to assist in reviewing images to be printed. As shown in the embodiment of FIG. 2A, the printing device 202 can include one or more print media handling devices 210, such as a bin or tray. In various embodiments of the invention, print media 211, such as paper, plastic, and cardstock, among others, can be accessed by the printing device 202 by having the media 211 provided on or in a media handling device, such as media handling device 210.

FIG. 2A also includes one or more print mode indicators 214 thereon for passively and/or actively indicating a print mode setting. In the embodiment shown in FIG. 2A, the device 202 has several indicators 215-1 . . . 215-N operable to indicate the one or more print modes of a print job being initiated. FIG. 2A illustrates that one, i.e. 215-3, of the indicators 215-1.215-N is illuminated thereby indicating that a specific print mode has been selected. In various embodiments, the one or more indicators 214 are also actuable buttons operable to physically select one or more print modes.

In various embodiments, the device 202 can be configured to allow the print mode to be reviewed and confirmed before printing begins. This allows the print media 211 to be changed, if it is the incorrect type for the print job being initiated. As those skilled in the art will appreciate from reading this disclosure, once the print media is changed, the change can be communicated to the device 202 by any manner, such as by the keypad 204.

In various embodiments, in addition to indicating the print mode being used, the indicators 214 indicate that a particular print mode is intended to be used and the device 202 is operable to receive either a confirmation of the use of that print mode, or a change to a different print mode. As those skilled in the art will appreciate from reading this disclosure, the confirmation or change in print mode can be communicated to the device 202 by any manner, such as by actuating a button incorporated into one of the indicators 215-1 . . . 215-N, or by the keypad 204. In various embodiments, the one or more indicators 215-1 . . . 215-N are automatically selected in connection with a print media sensor. The print mode can be changed by any manner, the invention is not so limiting. In these embodiments, a print media sensor interfaces with the indicators to reflect an appropriate print mode for a given type of print media sensed by the print media sensor.

Those skilled in the art will understand from reading this disclosure that an integrated circuit (IC), such as application specific integrated circuit (ASIC), can contain media sensing routines applicable to detect a print media type in a printing device. Such an IC can communicate to an analog/digital IC to drive circuitry operable to perform measurement routines in connection with sensors to detect the print media type. For example, sensors can be used to conduct specular and diffuse measurements on the print media.

As those skilled in the art will appreciate from reading this disclosure, the one or more indicators can be any single type or combination of indicators. For example, the indicator can be one or more audible signals, one or more illuminated indicators, or one or more flashing indicators, among others.

FIG. 2B illustrates an embodiment of a multi-function device 220, such as an All-in-One (AiO) device 220, suitable for use with various embodiments of the present invention. As one of ordinary skill in the art will appreciate upon reading this disclosure, the AiO device 220, illustrated in the embodiment of FIG. 2B, can operate as a stand alone device and can further be used as a printing device in a system such as the printing device 102 shown in the system 100 of FIG. 1.

In the embodiment of FIG. 2B, the multi-function device 220 is illustrated having one or more data input mechanisms. In the embodiment shown in FIG. 2B, the one or more data input mechanisms include one or more input keys 224, one or more memory media slots 226-1 and 226-2, and/or one or more data ports 228. As shown in the embodiment of FIG. 2B, the multi-function device 220 can include one or more print media handling components 233 for holding one or more pieces of print media 231. And, as shown in the embodiment of FIG. 2B, the multi-function device can include a scanning/copying input 232 and one or more display screen user interfaces 230.

As one of ordinary skill in the art will appreciate, the multi-function device embodiment of FIG. 2B is thus operable to obtain data, of any type, from any number of sources. As shown in the embodiment of FIG. 2B, the multi-function device 220 can also include one or more print mode indicators 234 and one or more selection buttons 236-1 . . . 236-N associated therewith. The print mode selectors 236-1. 236-N are shown as buttons that can be pressed to change or indicate the print mode desired. Those skilled in the art will appreciate from reading this disclosure that an indicator can be provided within a button, thereby providing a unified structure for both indicating and selecting the print mode.

FIG. 2C illustrates a block diagram embodiment of one or more components includable in a device, such as the devices shown in FIGS. 2A and 2B. The embodiment of FIG. 2C illustrates a device 240 including one or more processors 242 and one or more application modules 244, suitable for operating on software and computer executable instructions. In the embodiment of FIG. 2C, the device 240 is further illustrated having one or more resident memory mediums 246 and one or more removable or portable memory mediums and/or data ports 248 as the same have been described herein. In various embodiments, the one or more portable memory mediums can include selectably insertable memory mediums, such as memory cards. The invention, however, is not so limited.

The embodiment of FIG. 2C, also includes one or more print media sensors 250. Those skilled in the art will appreciate from reading this disclosure that the print media sensor can provide information including, but not limited to, media transparency, density, size (in one or two dimensions), reflectivity from specular and diffuse measurements, and the number of sheets of media in a location, among others. In the various embodiments utilizing one or more print media sensors 250, the information provided by the sensor 250 can facilitate several other functions. For example, if the one or more sensors 250 can identify the type of print media at a location, the device 240 can compare the print media type with the requirements of the print job being initiated and can decide whether to allow the job to print or to allow the job to be reviewed and confirmed or changed before it is printed.

As stated herein, various embodiments of the invention can be performed by software, application modules, and/or computer executable instructions, operable on the systems and devices described above or otherwise, for carrying out the aspects of the present invention. As one of ordinary skill in the art will appreciate upon reading this disclosure and practicing the invention, software, application modules, and/or computer executable instructions, suitable for carrying out the aspects of the present invention, can be resident in a single device, e.g. photo printing device 202 and/or AiO 220, or the same can be resident in more than one device across several and even many locations, such as in a distributed computing environment, e.g. system 100. The invention, however, is not limited to any particular operating environment or to software written in a particular programming language.

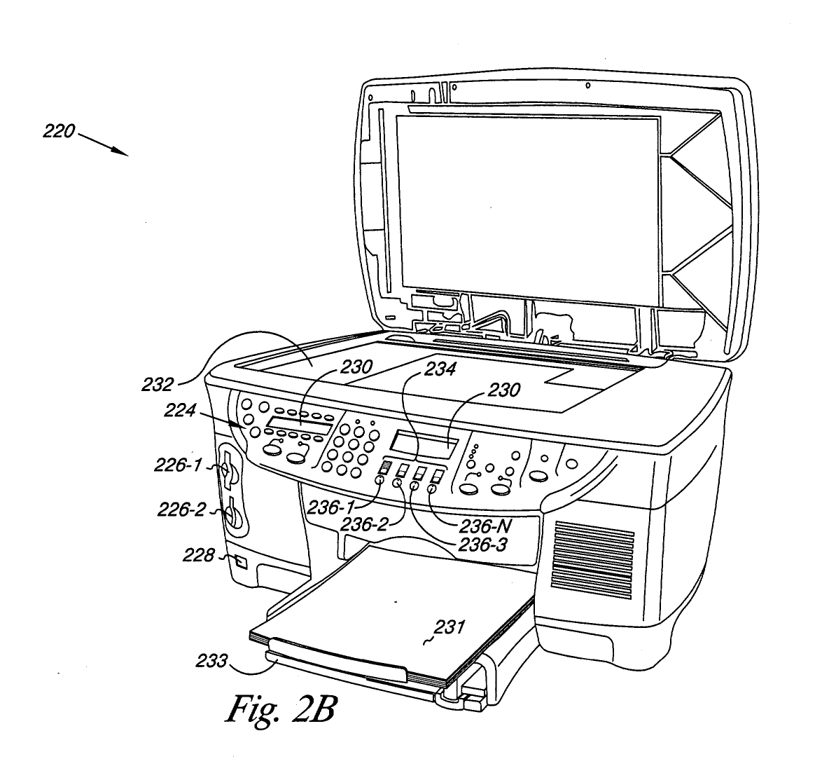

FIGS. 3-6 are block diagrams illustrating various method embodiments of the invention. Unless explicitly stated, the methods described below are not constrained to a particular order or sequence. Additionally, some of the so described methods or parts of the same method can occur or be performed at the same point in time.

FIG. 3 is a block diagram illustrating a method according to an embodiment of the present invention. In the embodiment of FIG. 3, a method for print job configuration is provided. As illustrated in the embodiment of FIG. 3, receiving print media data indicating a print media type available to a printing device at block 310. The method embodiment of FIG. 3 also includes configuring a print mode to accord with the received print media data at block 320. In various embodiments, configuring a print mode based on the received print media data includes configuring the print mode to provide active print mode adjustment. In various embodiments, configuring a print mode based on the received print media includes configuring the print mode to provide one or more different print settings from one or more print settings originally associated with a print job. In various embodiments, configuring a print mode includes displaying a print mode change on an outer panel of a printing device. In various embodiments, configuring a print mode includes configuring a print mode automatically based on a type of print media provided to the printing device.

In various embodiments, the method can also include sensing the type of print media present on a printing device using a print media type sensor located on a printing device.

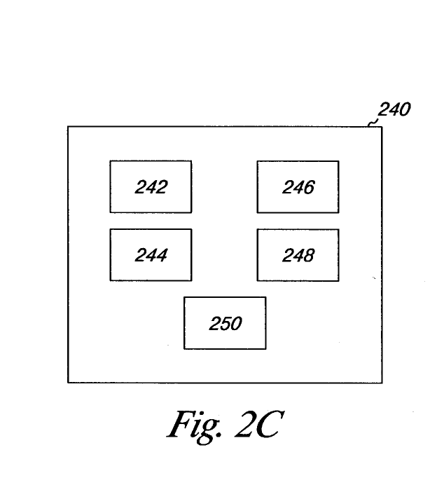

FIG. 4 is a block diagram illustrating a method according to an embodiment of the present invention. In the embodiment of FIG. 4, a method for print mode management is provided. The method embodiment of FIG. 4 includes configuring a print mode at block 410. In various embodiments, configuring a print mode includes configuring a set of printing property instructions associated with a print. In various embodiments, configuring a print mode includes configuring the print mode to provide passive print mode adjustment

The method embodiment of FIG. 4 also includes receiving print media data indicating a print media type available to a printing device at block 420. In various embodiments, receiving print media data includes receiving print media data from a media type sensor located on a printing device.

The method embodiment of FIG. 4 also includes optimizing printed output to accord with the received print media data at block 430. In various embodiments the method can also include signaling when the received print media data does not accord to a set of print settings in a print job. In various embodiments, the method can also include displaying a print mode on a printing device based on the received print media data.

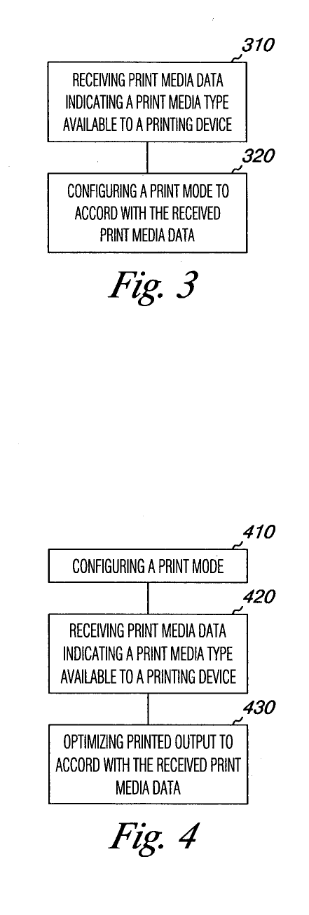

FIG. 5 is a block diagram illustrating a method according to an embodiment of the present invention. In the embodiment of FIG. 5, a method for print job configuration is provided. As illustrated in the embodiment of FIG. 5, the method includes sensing a print media type provided to a printing device at block 510. In various embodiments, sensing a print media type provided to a printing device includes sensing the print media type using a print media sensor associated with the printing device.

The method embodiment of FIG. 5 also includes, communicating the sensed print media type to a control panel on the printing device at block 520. In various embodiments, communicating the sensed print media type to a control panel on the printing device includes self-messaging a change in the print media type to the control panel. In various embodiments, self-messaging a change in the print media type includes illuminating an icon representing a print media type.

The method embodiment of FIG. 5, also includes enabling print mode selection for a print job based on the sensed print media type at block 530. In various embodiments, enabling print mode selection for a print job based on the sensed print media type includes automatically changing one or more print settings to correspond to the sensed print media type. In various embodiments, enabling print mode selection for a print job based on the sensed print media type includes signaling that a sensed print media type does not correspond to one or more print settings received in a print job from a printer driver. In various embodiments, enabling print mode selection for a print job based on the sensed print media type includes enabling a physical selection of one or more print modes on the control panel of the printing device.

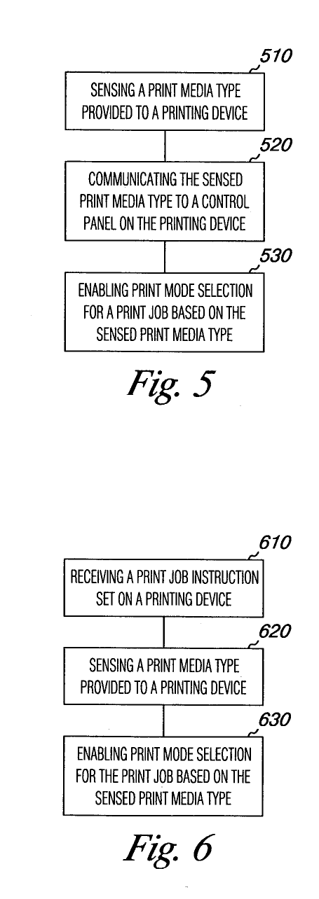

FIG. 6 is a block diagram illustrating a method according to an embodiment of the present invention. In the embodiment of FIG. 6, a method for print job configuration is provided. As illustrated in the embodiment of FIG. 6, the method includes receiving a print job instruction set on a printing device at block 610.

The method embodiment of FIG. 6 also includes sensing a print media type provided to a printing device at block 620. In various embodiments, sensing a print media type provided to a printing device includes indicating a print mode option to a control panel of the printing device based on the sensed print media type. In various embodiments, indicating a print mode option to the control panel includes communicating the sensed print media type to the control panel. In various embodiments, indicating a print mode option to the control panel includes displaying a print mode which corresponds to the sensed print media type.

The method embodiment of FIG. 6 also includes, enabling print mode selection for a print job based on the sensed print media type at block 630. In various embodiments, enabling print mode selection for a print job based on the sensed print media type includes enabling a physical selection of one or more print modes on the control panel of the printing device. In various embodiments, enabling print mode selection for a print job based on the sensed print media type includes changing a print mode in a manner which bypasses one or more print mode settings received from a printer driver.

In various embodiments, the method further includes comparing the sensed print media type to a print job instruction set received from a printer driver.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for print job configuration, comprising:
receiving print media data indicating a print media type available to a printing device; and
configuring a print mode displayable by an indicator located on the printing device to accord with the received print media data.

2. The method of claim 1, wherein the method further includes sensing a type of print media present on a printing device.

3. The method of claim 1, wherein configuring a print mode based on the received print media data includes configuring the print mode to provide active print mode adjustment.

4. The method of claim 1, wherein configuring a print mode based on the received print media data includes changing a print setting originally associated with a print job to a new setting.

5. The method of claim 1, wherein configuring a print mode includes displaying a print mode change on a printing device.

6. The method of claim 1, wherein configuring a print mode includes configuring a print mode automatically based on a type of print media provided to the printing device.

7. A method for print mode management, comprising:
configuring a print mode;
receiving print media data indicating a print media type available to a printing device; and
providing an indication of the configured print mode to a control panel.

8. The method of claim 7, wherein receiving print media data includes receiving print media data from a media type sensor located on a printing device.

9. The method of claim 7, wherein configuring a print mode includes configuring a set of printing property instructions associated with a print job.

10. The method of claim 9, further comprising signaling when the received print media data does not accord to the set of printing property instructions.

11. The method of claim 7, further comprising displaying a print mode on a printing device based on the received print media data.

12. The method of claim 7, wherein configuring a print mode includes configuring the print mode to provide passive print mode adjustment.

13. A method for print job configuration, comprising:
sensing a print media type provided to a printing device; and
communicating the sensed print media type to a control panel on the printing device; and
enabling print mode selection for a print job based on the sensed print media type.

14. The method of claim 13, wherein sensing a print media type provided to a printing device includes sensing the print media type using a print media sensor associated with the printing device.

15. The method of claim 13, wherein communicating the sensed print media type to a control panel on the printing device includes self-messaging a change in the print media type to the control panel.

16. The method of claim 15, wherein self-messaging a change in the print media type includes illuminating an icon representing a print media type.

17. The method of claim 13, wherein enabling print mode selection for a print job based on the sensed print media type includes automatically changing one or more print settings to correspond to the sensed print media type.

18. The method of claim 13, wherein enabling print mode selection for a print job based on the sensed print media type includes signaling that a sensed print media type does not correspond to one or more print settings received in a print job from a printer driver.

19. The method of claim 13, wherein enabling print mode selection for a print job based on the sensed print media type includes enabling a physical selection of one or more print modes on the control panel of the printing device.

20. A computer readable medium having a set of computer executable instructions thereon for causing a device to perform a method, the method comprising:
sensing a print media type provided to a printing device; and
enabling print mode selection on a control panel of the printing device based on the sensed print media type.

21. The medium of claim 20, wherein sensing a print media type provided to a printing device includes indicating a print mode option to a control panel of the printing device based on the sensed print media type.

22. The medium of claim 21, wherein indicating a print mode option to the control panel includes communicating the sensed print media type to the control panel.

23. The medium of claim 21, wherein indicating a print mode option to the control panel includes displaying a print mode which corresponds to the sensed print media type.

24. The medium of claim 20, wherein the method further includes comparing the sensed print media type to the print job instruction set received from a printer driver.

25. The medium of claim 20, wherein enabling print mode selection for a print job based on the sensed print media type includes enabling a physical selection of one or more print modes on the control panel of the printing device.

26. The medium of claim 20, wherein enabling print mode selection for a print job based on the sensed print media type includes changing a print mode in a manner which bypasses one or more print mode settings received from a printer driver.

27. A printing device, comprising:
a processor;
a memory operably coupled to the processor;
a print media sensor operably coupled to the processor and the memory; and
logic means operable on the device to change a print mode based on a print media type sensed by the print media sensor.

28. The printing device of claim 27, wherein the logic means is operable to signal a print mode indication to a control panel on the printing device.

29. The printing device of claim 27, wherein the logic means is operable to select one or more print modes.

30. The printing device of claim 27, wherein the logic means is operable to enable a physical selection of one or more print modes on a control panel of the printing device.

31. The printing device of claim 27, further comprising a panel display including print mode indicators, each indicator different in appearance and function.

32. The printing device of claim 31, wherein the print mode indicators includes a number of illuminable icons, and wherein each illuminable icon represents a different print mode.

32. The printing device of claim 31, wherein the print mode indicators each include a passive function and an active function.

33. The printing device of claim 32, wherein a passive function for each of the print mode indicators includes a physical actuation to select a print mode associated with the print mode indicator.

34. The printing device of claim 32, wherein an active function for each of the print mode indicators includes an automatic selection of one of the number of print mode indicators by the logic means.

35. A printing system, comprising:
a printing device, wherein the printing device includes;
a processor;
a memory operably coupled to the processor;
a print media sensor operably coupled to the processor and the memory; and
a print mode selection mechanism operable on the device to change a print mode based on a print media type sensed by the print media sensor; and
a host device connected to the printing device and operable to transmit one or more print job instructions over one or more data links.
